(19) United States
(12) Patent Application Publication
(10) Pub. No.: US 2024/0339849 A1
(43) Pub. Date: Oct. 10, 2024

(54) STORAGE SYSTEM CONFIGURED FOR USE WITH AN ENERGY MANAGEMENT SYSTEM

(71) Applicant: Enphase Energy, Inc., Petaluma, CA (US)

(72) Inventors: Blake Richard LUNDSTROM, Lakewood, CO (US); Donald Richard ZIMMANCK, Sebastopol, CA (US)

(21) Appl. No.: 18/623,274

(22) Filed: Apr. 1, 2024

Related U.S. Application Data
(60) Provisional application No. 63/457,197, filed on Apr. 5, 2023.

(51) Int. Cl. H02J 7/00

(52) U.S. Cl. CPC H02J 7/0048; H02J 7/00716; H02J 7/007182; H02J 2207/20

(57) ABSTRACT

A storage system configured for use with an energy management system is provided and comprises a battery, a power converter comprising a plurality of microinverters coupled to the battery, and a battery management unit coupled to the battery and the power converter and configured to receive a local coulomb count from each microinverter of the plurality of microinverters, calculate a total battery coulomb count, obtain a voltage measurement of the battery, and calculate a state-of-charge estimate using the calculated total battery coulomb count and the obtained voltage measurement.

### CROSS-REFERENCE TO RELATED APPLICATIONS

The present application claims the benefit of and priority to U.S. Provisional Application Ser. No. 63/457,197, filed on Apr. 5, 2023, the entire contents of which is incorporated herein by reference.

### BACKGROUND

### 1. Field of the Disclosure

Embodiments of the present disclosure generally relate to power systems and, more particularly, to methods and apparatus for distributed state-of-charge (SoC) estimation of a battery.

### 2. Description of the Related Art

Conventional AC storage systems comprise one or more batteries (e.g., lithium-ion batteries) and provide a required energy storage (kWh) and a required AC power (KW). Conventional AC storage systems are designed with a battery management unit/system (BMU/BMS) which is responsible for protecting the one or more batteries from faults, balancing the battery cells, and calculating battery telemetry such as the SoC. SoC is an important parameter of the lithium-ion battery in terms of indicating a proper battery state, providing an available energy, for calculating SoH (state-of-health), etc. A high accuracy of the SoC is required (e.g., <2%). In some instances, such as when there is a single battery and a BMU connected to a power converter, SoC estimation algorithms such as coulomb counting and Kalman filtering rely on having a single voltage and current measurement of a battery pack of the AC storage systems to accurately estimate the SoC during operation.

The single voltage/current measurement requirement can add significant cost and complexity to the BMU, as measuring the large DC currents in the battery packs requires expensive sensors or current shunts, high current terminals, large PCB traces, and expensive analog front-ends to process the voltage/current measurement signal. Additionally, the chargers/inverters, which typically connect to the one or more batteries, often have individual current measurements. While the current measurements can be transmitted to the BMU using, for example, a communications system and aggregated digitally, if the currents have high frequency content (e.g., such as in a single-phase inverter system), the speed and synchronization requirements for the communications system make using such systems impractical for transmitting the current measurements to the BMU. Accordingly, there is a need to develop a distributed SoC estimation technique which does not rely on high frequency communications.

Therefore, the inventors have found improved methods and apparatus for distributed state-of-charge (SoC) estimation of a battery, without relying on high frequency communications.

### SUMMARY

In accordance with some aspects of the present disclosure, a storage system configured for use with an energy management system comprises a battery, a power converter comprising a plurality of microinverters coupled to the battery, and a battery management unit coupled to the battery and the power converter and configured to receive a local coulomb count from each microinverter of the plurality of microinverters, calculate a total battery coulomb count, obtain a voltage measurement of the battery, and calculate a state-of-charge estimate using the calculated total battery coulomb count and the obtained voltage measurement.

In accordance with some aspects of the present disclosure, a method for managing a storage system configured for use with an energy management system comprises receiving a local coulomb count from each microinverter of a plurality of microinverters, calculating a total battery coulomb count, obtaining a voltage measurement of a battery, and calculating a state-of-charge estimate using the calculated total battery coulomb count and the obtained voltage measurement.

In accordance with some aspects of the present disclosure, a non-transitory computer readable storage medium has stored thereon instructions that when executed by a processor perform a method for managing a storage system configured for use with an energy management system. The method comprises receiving a local coulomb count from each microinverter of a plurality of microinverters, calculating a total battery coulomb count, obtaining a voltage measurement of a battery, and calculating a state-of-charge estimate using the calculated total battery coulomb count and the obtained voltage measurement.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a block diagram of an AC battery system, in accordance with at least some embodiments of the present disclosure;

FIG. 3 is a flowchart of a method for managing a storage system configured for use with an energy management system, in accordance with at least one embodiment of the present disclosure; and

FIG. 4 is a schematic diagram of a system for power conversion, in accordance with at least some embodiments of the present disclosure.

### DETAILED DESCRIPTION

In accordance with the present disclosure, methods and apparatus for calculating a state-of-charge (SoC) of a battery of a storage system are disclosed herein. For example, a storage system can be configured for use with an energy management system and can comprise a battery, a power converter comprising a plurality of microinverters coupled to the battery, and a battery management unit. The battery management unit can be coupled to the battery and the power converter and configured to receive a local coulomb count from each microinverter of the plurality of microinverters, calculate a total battery coulomb count, obtain a voltage measurement from the battery, and calculate a state-of-charge estimate using the calculated total battery coulomb count and the obtained voltage measurement. Unlike conventional methods and apparatus, the methods and apparatus described herein provide a distributed SoC estimation technique which does not rely on high frequency communications, without adding significant cost and complexity to a BMU.

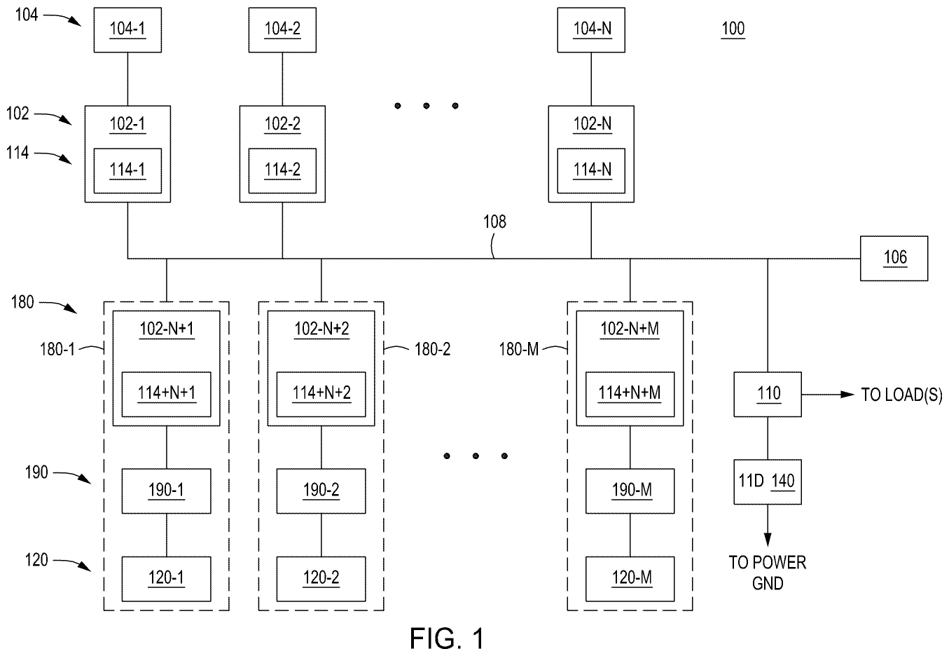

FIG. 1 is a block diagram of a system 100 (energy management system) for power conversion using one or more embodiments of the present disclosure. This diagram only portrays one variation of the myriad of possible system configurations and devices that may utilize the present disclosure.

The system 100 is a microgrid that can operate in both an islanded state and in a grid-connected state (i.e., when connected to another power grid (such as one or more other microgrids and/or a commercial power grid). The system 100 comprises a plurality of power converters 102-1, 102-2, . . . 102-N, 102-N+1, and 102-N+M collectively referred to as power converters 102 (which also may be called power conditioners); a plurality of DC power sources 104-1, 104-2, . . . 104-N, collectively referred to as power sources 104; a plurality of energy storage devices/delivery devices 120-1, 120-2, . . . 120-M collectively referred to as energy storage/delivery devices 120; a system controller 106; a plurality of BMUs 190-1, 190-2, . . . 190-M (battery management units) collectively referred to as BMUs 190; a system controller 106; a bus 108; a load center 110; and an IID 140 (island interconnect device) (which may also be referred to as a microgrid interconnect device (MID)). In some embodiments, such as the embodiments described herein, the energy storage/delivery devices are rechargeable batteries (e.g., multi-C-rate collection of AC batteries) which may be referred to as batteries 120, although in other embodiments the energy storage/delivery devices may be any other suitable device for storing energy and providing the stored energy. Generally, each of the batteries 120 comprises a plurality cells that are coupled in series, e.g., eight cells coupled in series to form a battery 120.

Each power converter 102-1, 102-2 . . . 102-N is coupled to a DC power source 104-1, 104-2 . . . 104-N, respectively, in a one-to-one correspondence, although in some other embodiments multiple DC power sources may be coupled to one or more of the power converters 102. The power converters 102-N+1, 102-N+2 . . . 102-N+M are respectively coupled to plurality of energy storage devices/delivery devices 120-1, 120-2 . . . 120-M via BMUs 190-1, 190-2 . . . 190-M to form AC batteries 180-1, 180-2 . . . 180-M, respectively. Each of the power converters 102-1, 102-2 . . . 102-N+M comprises a corresponding controller 114-1, 114-2 . . . 114-N+M (collectively referred to as the inverter controllers 114) for controlling operation of the power converters 102-1, 102-2 . . . 102-N+M.

In some embodiments, such as the embodiment described below, the DC power sources 104 are DC power sources and the power converters 102 are bidirectional inverters such that the power converters 102-1 . . . 102-N convert DC power from the DC power sources 104 to grid-compliant AC power that is coupled to the bus 108 (AC-DC power converters), and the power converters 102-N+1 . . . 102-N+M convert (during energy storage device discharge) DC power from the batteries 120 to grid-compliant AC power that is coupled to the bus 108 and also convert (during energy storage device charging) AC power from the bus 108 to DC output that is stored in the batteries 120 for subsequent use. The DC power sources 104 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In other embodiments the power converters 102 may be other types of converters (such as DC-DC power converters), and the bus 108 is a DC power bus.

The power converters 102 are coupled to the system controller 106 via the bus 108 (which also may be referred to as an AC line or a grid). The system controller 106 generally comprises a CPU coupled to each of support circuits and a memory that comprises a system control module for controlling some operational aspects of the system 100 and/or monitoring the system 100 (e.g., issuing certain command and control instructions to one or more of the power converters 102, collecting data related to the performance of the power converters 102, and the like). The system controller (processor) 106 is capable of communicating with the power converters 102 by wireless and/or wired communication (e.g., power line communication) for providing certain operative control and/or monitoring of the power converters 102.

In some embodiments, the system controller 106 may be a gateway that receives data (e.g., performance data) from the power converters 102 and communicates (e.g., via the Internet) the data and/or other information to a remote device or system, such as a master controller (not shown). Additionally or alternatively, the gateway may receive information from a remote device or system (not shown) and may communicate the information to the power converters 102 and/or use the information to generate control commands that are issued to the power converters 102.

The power converters 102 are coupled to the load center 110 via the bus 108, and the load center 110 is coupled to the power grid via the IID 140. When coupled to the power grid (e.g., a commercial grid or a larger microgrid) via the IID 140, the system 100 may be referred to as grid-connected; when disconnected from the power grid via the IID 140, the system 100 may be referred to as islanded. The IID 140 determines when to disconnect from/connect to the power grid (e.g., the IID 140 may detect a grid fluctuation, disturbance, outage or the like) and performs the disconnection/connection. Once disconnected from the power grid, the system 100 can continue to generate power as an intentional island, without imposing safety risks on any line workers that may be working on the grid, using the droop control techniques described herein. The IID 140 comprises a disconnect component (e.g., a disconnect relay) for physically disconnecting/connecting the system 100 from/to the power grid. In some embodiments, the IID 140 may additionally comprise an autoformer for coupling the system 100 to a split-phase load that may have a misbalance in it with some neutral current. In certain embodiments, the system controller 106 comprises the IID 140 or a portion of the IID 140.

The power converters 102 convert the DC power from the DC power sources 104 and discharging batteries 120 to grid-compliant AC power and couple the generated output power to the load center 110 via the bus 108. The power is then distributed to one or more loads (for example to one or more appliances) and/or to the power grid (when connected to the power grid). Additionally or alternatively, the generated energy may be stored for later use, for example using batteries, heated water, hydro pumping, H₂O-to-hydrogen conversion, or the like. Generally, the system 100 is coupled to the commercial power grid, although in some embodiments the system 100 is completely separate from the commercial grid and operates as an independent microgrid.

In some embodiments, the AC power generated by the power converters 102 is single-phase AC power. In other embodiments, the power converters 102 generate three-phase AC power.

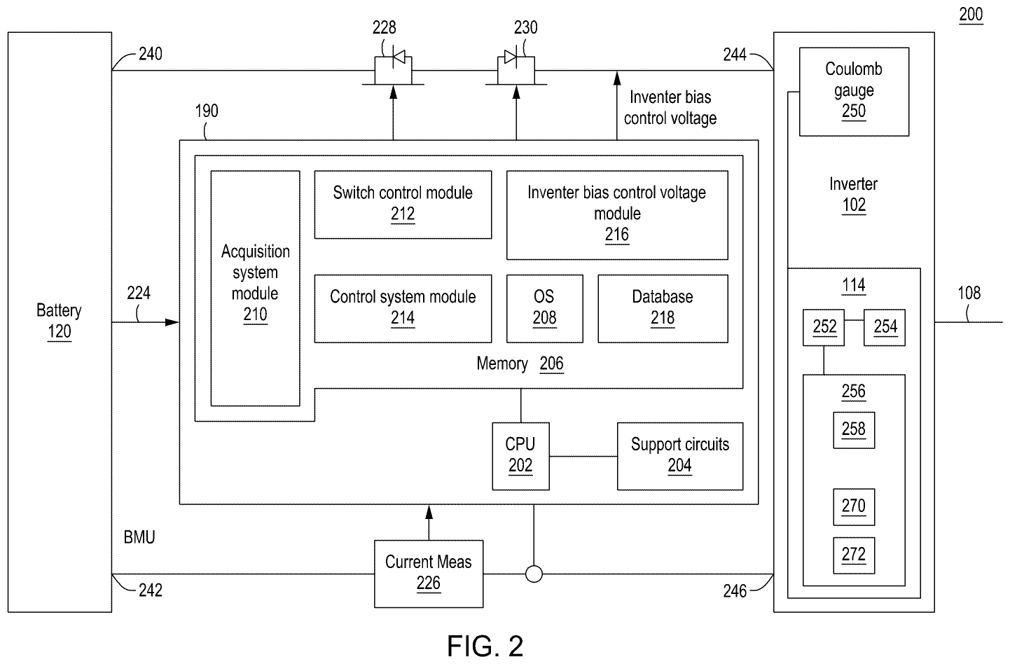

A storage system configured for use with an energy management system, such as the Enphase® Energy System, is described herein. For example, FIG. 2 is a block diagram of an AC battery system 200 (e.g., a storage system) in accordance with one or more embodiments of the present disclosure.

The AC battery system 200 comprises a BMU 190 coupled to a battery (e.g., the battery 120) and two or more power converters s (e.g., the power converters 102). In at least some embodiments, the battery 120 can comprise a plurality of cells (not shown) and the power converters 102 can comprise four embedded converters (e.g., four embedded microinverters). In at least some embodiments, the battery 120 can be the IQ Battery 3 (or the IQ Battery 10) and the microinverters can be the IQ8X-BAT microinverters, both available from Enphase®. A pair of metal-oxide-semiconductor field-effect transistors (MOSFETs) switches-switches 228 and 230—are coupled in series between a first terminal 240 of the battery 120 and a first terminal of the inverter 144 such the body diode cathode terminal of the switch 228 is coupled to the first terminal 240 of the battery 120 and the body diode cathode terminal of the switch 230 is coupled to the first terminal 244 of the power converter 102. The gate terminals of the switches 228 and 230 are coupled to the BMU 190.

A second terminal 242 of the battery 120 is coupled to a second terminal 246 of the power converter 102 via a current measurement module 226 which measures the current flowing between the battery 120 and the power converter 102.

The BMU 190 is coupled to the current measurement module 226 for receiving information on the measured current, and also receives an input 224 from the battery 120 indicating the battery cell voltage and temperature. The BMU 190 is coupled to the gate terminals of each of the switches 228 and 230 for driving the switch 228 to control battery discharge and driving the switch 230 to control battery charge as described herein. The BMU 190 is also coupled across the first terminal 244 and the second terminal 246 for providing an inverter bias control voltage (which may also be referred to as a bias control voltage) to the inverter 102 as described further below.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery 120 to the power converter 102 through the body diode of the switch 230. When the switch 228 is inactive while the switch 230 is active, battery charge is enabled to allow current flow from the power converter 102 to the battery 120 through the body diode of the switch 228. When both switches 228 and 230 are active, the system is in a normal mode where the battery 120 can be charged or discharged.

The BMU 190 comprises support circuits 204 and a memory 206 (e.g., non-transitory computer readable storage medium), each coupled to a CPU 202 (central processing unit). The CPU 202 may comprise one or more processors, microprocessors, microcontrollers and combinations thereof configured to execute non-transient software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller (processor) functionality described herein. The BMU 190 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 190 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the inverter controller 114 that can be supported by the CPU capabilities. In some embodiments, the OS 208 may be one of a number of commercially available operating systems such as, but not limited to, LINUX, Real-Time Operating System (RTOS), and the like.

The memory 206 stores non-transient processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 190 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the cell voltage and temperature information from the battery 120 via the input 224, obtains the current measurements provided by the current measurement module 226, and provides the cell voltage, cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state-of-charge (SoC) analysis (e.g., coulomb counting module 250 (or coulomb gauge) for determining current flow and utilizing the current flow in estimating the battery SoC; synchronizing estimated SoC values to battery voltages (such as setting SoC to an upper bound, such as 100%, at maximum battery voltage; setting SoC to a lower bound, such as 0%, at a minimum battery voltage); turning off SoC if the power converter 102 never drives the battery 120 to these limits; and the like), balancing (e.g., autonomously balancing the charge across all cells of a battery to be equal, which may be done at the end of charge, at the end of discharge, or in some embodiments both at the end of charge and the end of discharge). By establishing upper and lower estimated SoC bounds based on battery end of charge and end of discharge, respectively, and tracking the current flow and cell voltage (i.e., battery voltage) between these events, the BMU 190 determines the estimated SoC.

The inventors have found a new algorithm for determining the SoC on a battery when the battery is being charged/discharged by multiple converters (e.g., multiple microinverters), where each microinverter of the multiple microinverters measures a corresponding voltage/current. That is, because the multiple microinverters are in parallel, the multiple microinverters and the BMU both use an aggregate voltage measurement. For example, each microinverter measures current for integrating and calculating its own coulomb count. An aggregate current measurement, however, is not measured or computed by the BMU (e.g., by summing individual current measurements at the microinverter) for SOC estimation.

The BMU implements a battery SoC estimation algorithm that requires inputs of (i) battery pack voltage, which the BMU measures locally, and (ii) coulomb counts (e.g., obtained by integrating current over time) from each of the microinverters, which can then be repeated 0.1 to 10 Hz or times per second. In at least some embodiments, can then be repeated 0.1 to 10 Hz or times per second. In at least some embodiments, can then be repeated 1 to 5 Hz or times per second.

For example, the microinverters update the local coulomb counts, Q_{ci} and send the coulomb counts, Q_{ci} to the BMU. The BMU receives N coulomb counts Q_{c1} . . . Q_{cN}. The BMU obtains a total battery pack coulomb count by summing all the received coulomb counts using Equation (1) Q_{ctot}=sum (Q_{c1} . . . Q_{cN}). Next, the BMU obtains a battery pack voltage measurement, V_{batt}, using local measurement system (e.g., obtained from one of the microinverters since the microinverters are connected in parallel). In at least some embodiments, V_{batt} can be measured via a dedicated measurement system on the BMU. The BMU computes a battery SoC estimate using its SoC estimation algorithm and Equation (2):

$$SoC = f ( {Q}_{ctot} , {V}_{batt} ) . \qquad ( 2 )$$

Compared to conventional methods and apparatus, the computational requirements for the methods and apparatus described herein are lower for the individual microinverters. That is, the individual microinverters do not have to implement a local version of an SoC estimation algorithm, which would require the individual microinverters to use local limited computational resources-CPU cycles, memory to store lookup tables, accumulate values, etc. Rather, an individual microinverter can use an accumulated current value that is calculated by the individual microinverter and, thus, the more complex SoC estimate can be performed by the BMU, where computational resources for that purpose can be allocated. For example, in at least some embodiments the individual microinverter can comprise/use an IC (which is, typically, very accurate and has a relatively high bandwidth) to calculate the accumulated current value.

The inventive concepts described herein for determining SoC estimation provide high speed communication, and measurement of total battery current is not needed (e.g., cost, complexity avoided).

Continuing with reference to FIG. 2, the inverter controller 114 comprises support circuits 254 and a memory 256, each coupled to a CPU 252 (central processing unit). The CPU 252 may comprise one or more processors, microprocessors, microcontrollers and combinations thereof configured (programmed) to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The inverter controller 114 may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The inverter controller 114 may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258 (operating system), if necessary, of the inverter controller 114 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

The BMU 190 communicates with the system controller 106 to perform balancing of the batteries 120 (e.g., multi-C-rate collection of AC batteries) based on a time remaining before each of the batteries are depleted of charge, to perform droop control (semi-passive) which allows the batteries to run out of charge at substantially the same time, and perform control of the batteries to charge batteries having less time remaining before depletion using batteries having more time remaining before depletion, as described in greater detail below.

The inventors provide herein a method for SoC estimation for battery systems that improves upon the state-of-the-art SoC estimation methods by relaxing the need for high-speed communications (e.g., instead use low-speed, low-bandwidth communications link). For example, a coulomb counter at each output power converter is configured to provide a resulting coulomb count (Q_{c1}, Q_{c2}, Q_{cN}) to a BMU, as opposed to using current measurements directly. Thus, by distributing the coulomb counting to local microinverters, integration error can be minimized to lower levels when compared to the state-of-the-art methods because the distributed coulomb counters can use the highest resolution current measurements available locally (e.g., as opposed to the bandwidth of the communications link which impose practical limitations on the resolution of current measurements that are used in the state-of-the-art approach). Additionally lower computational complexity is required at the individual microinverter because, as noted above, only current is being accumulated vs. a more complex SoC algorithm involving voltage measurements, coulomb counts, look up tables, etc. In accordance with at least some embodiments, the individual coulomb counts can be provided at a relatively slow frequency via a low-speed communications link because SoC measurements on battery-powered systems of reasonable capacity typically vary relatively slowly. Thus, the methods described herein achieve better coulomb counting accuracy and requires only a low-speed, low-bandwidth communication link while still working with a centralized SoC estimation algorithm, which, as noted above, allows for a lower complexity and lower cost battery system solution. Additionally, measurement of total battery current is not needed (e.g., cost, complexity avoided). That is, when using the methods described herein for SoC estimation, a dedicated master battery switch need not be used (e.g., the microinverters are coordinated instead) and the BMS logic can be moved to any computational platform (e.g., the BMU no longer has to be co-located within the battery pack).

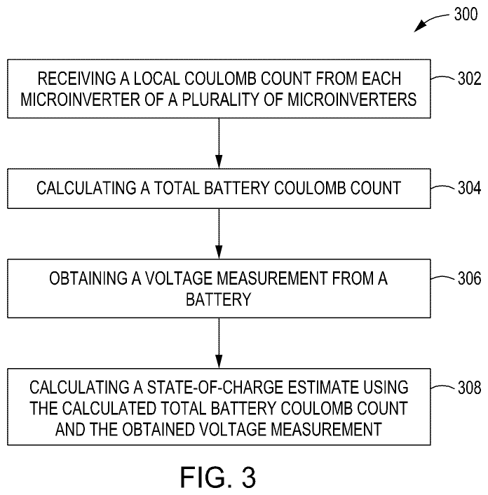

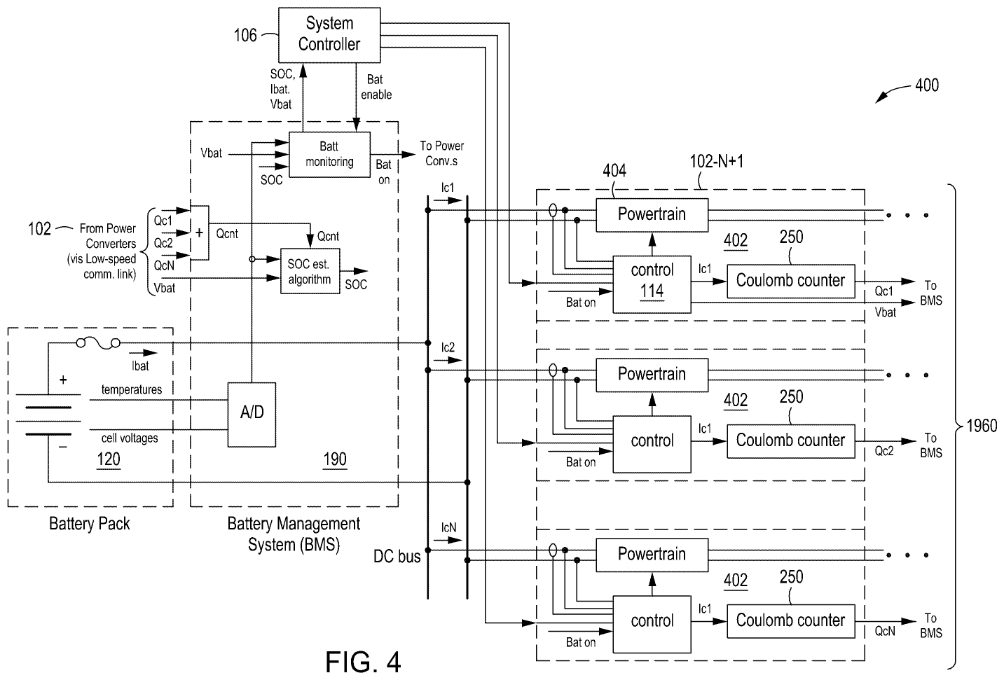

FIG. 3 is a flowchart of a method 300 for managing a storage system configured for use with an energy management system, and FIG. 4 is a schematic diagram of a system 400 for power conversion, in accordance with at least one embodiment of the present disclosure. The method 300 can be performed using power converters 102-1 . . . 102-N to convert DC power from the DC power sources 104 to grid-compliant AC power, using the power converters 102-N+1 . . . 102-N+M to convert DC power from the batteries 120 to grid-compliant AC power, and/or using DC-DC converters. For illustrative purposes, the method 300 is described configured for use with an AC rechargeable battery and the power converters configured for use with the AC rechargeable battery. For example, a power converter 102-N+1 comprises three microinverters that are connected to the BMU 190 and the battery 120.

For example, at 302, the method 300 comprises receiving a local coulomb count from each microinverter of a plurality of microinverters. For example, each microinverter 402 of the power converter 102-N+1 can use coulomb counting to calculate a local coulomb count. For example, current I_{bat} from the battery 120 can be supplied to each microinverter 402. For example, I_{bat} is divided into current I_{c1}, I_{c2}, and I_{c3} which are supplied to each microinverter 402. For example, the current I_{c1}, I_{c2}, and I_{cs} are supplied to respective inputs of a powertrain module 404 and measured by the inverter controller 114 of each microinverter 402. The current measurement output of the inverter controller 114 is sent to the coulomb counting module 250 of each microinverter 402. Next, each coulomb count is transmitted from the coulomb counting module 250 to the BMU 190. For example, each coulomb counting module 250 sends a Qc output to the controller, which, in turn, sends the Qc output to the BMU 190. For example, Q_{c1} to Q_{cN} outputs respectively from each coulomb counting module 250 are sent to a corresponding controller that subsequently sends the Q_{c1} to Q_{cN} outputs to an input of the Qcnt module of the BMU 190. In at least some embodiments, 302 can be repeated at about 0.1 to 10 Hz or times per second. In at least some embodiments, can then be repeated 1 to 5 Hz or times per second. Also, the coulomb counter could technically be part of the same physical controller (but is logically different as the drawing shows).

Next, at 304, the method 300 comprises calculating a total battery coulomb count. For example, the BMU 190 obtains a total battery pack coulomb count by summing all the received coulomb counts. For example, the Qcnt module calculates a sum of the battery coulomb count using Equation (1) Q_{ctot}=sum(Q_{c1} . . . Q_{cN}) and inputs the calculated Q_{ctot} to a SoC estimation module.

Next, at 306, the method 300 comprises obtaining a voltage measurement from a battery. For example, the BMU 190 obtains a battery pack voltage measurement, V_{batt}, using local measurement system. Using the local measurement system allows the BMU 190 to obtain V_{batt} measurement at relatively high speeds (and at relatively low cost, compared to the current measurement) if needed. As the measurement resolution of V_{batt} required by specific SoC estimation algorithms varies, in some embodiments, V_{batt} can be obtained/sent from one of the microinverters (e.g., the top microinverter).

Next, at 308, the method 300 comprises calculating a state-of-charge estimate using the calculated total battery coulomb count and the obtained voltage measurement. For example, the SoC estimation module of the BMU 190 computes a battery SoC estimate using its SoC estimation algorithm and Equation (2):

$$SoC = f ( {Q}_{ctot} , {V}_{batt} ) . \qquad ( 2 )$$

Next, the SoC estimation module outputs the SoC estimation to a battery monitoring module that outputs the SoC estimation to the system controller 106 for control of the system 100 as needed.

In at least some embodiments, such as when there are four microinverters, one of the microinverters can be designated as a master microinverter that is configured to receive coulomb counts from the other three microinverters (slave microinverters) and transmit the coulomb counts to the BMU 190, which, in turn, can control charging/discharging the battery 120 based on the received coulomb counts and V_{batt}, as described above.

In at least some embodiments, at 306 coulomb counting of the plurality of microinverter can be performed @ (N−1) Hz, where N is the number of microinverters. Thus, when there are a total of four (4) micro inverters, 306 would run three (3) times a second (e.g., every time a coulomb count is received from another microinverter).

While the foregoing is directed to embodiments of the present disclosure, other and further embodiments of the disclosure may be devised without departing from the basic scope thereof, and the scope thereof is determined by the claims that follow.

1. A storage system configured for use with an energy management system, comprising:
a battery;
a power converter comprising a plurality of microinverters coupled to the battery; and
a battery management unit coupled to the battery and the power converter and configured to receive a local coulomb count from each microinverter of the plurality of microinverters, calculate a total battery coulomb count, obtain a voltage measurement of the battery, and calculate a state-of-charge estimate using a calculated total battery coulomb count and an obtained voltage measurement.

2. The storage system of claim 1, wherein the battery management unit is configured to receive the local coulomb count from each microinverter at about 0.1 to 10 Hz or times per second.

3. The storage system of claim 1, wherein the state-of-charge estimate of the battery is calculated using Equation (1):
$$SoC = f ( {Q}_{ctot} , {V}_{batt} ) , \qquad ( 1 )$$
where Q_{ctot}=sum(Q_{c1} . . . Q_{cN}), and the voltage measurement is a battery pack voltage measurement V_{batt}.

4. The storage system of claim 1, wherein the power converter comprises four microinverters.

5. The storage system of claim 1, wherein the local coulomb count is performed @ (N−1) Hz, where N is a number of microinverters.

6. The storage system of claim 1, wherein the voltage measurement is obtained locally by the battery management unit.

7. The storage system of claim 1, wherein the power converter is one of an AC-DC power converter or a DC-DC power converter.

8. A method for managing a storage system configured for use with an energy management system, comprising:
receiving a local coulomb count from each microinverter of a plurality of microinverters of a power converter;
calculating a total battery coulomb count;
obtaining a voltage measurement of a battery; and
calculating a state-of-charge estimate using a calculated total battery coulomb count and an obtained voltage measurement.

9. The method of claim 8, wherein receiving the local coulomb count occurs at about 0.1 to 10 Hz or times per second.

10. The method of claim 8, wherein the state-of-charge estimate of the battery is calculated using Equation (1):
$$SoC = f ( {Q}_{ctot} , {V}_{batt} ) , \qquad ( 1 )$$
where Q_{ctot}=sum (Q_{c1} . . . Q_{cN}), and the voltage measurement is a battery pack voltage measurement V_{batt}.

11. The method of claim 8, wherein the power converter comprises four microinverters.

12. The method of claim 11, wherein the local coulomb count is performed @ (N−1) Hz, where N is a number of microinverters.

13. The method of claim 12, wherein the power converter is one of an AC-DC power converter or a DC-DC power converter.

14. A non-transitory computer readable storage medium having stored thereon instructions that when executed by a processor perform a method for managing a storage system configured for use with an energy management system, comprising:
receiving a local coulomb count from each microinverter of a plurality of microinverters of a power converter;
calculating a total battery coulomb count;
obtaining a voltage measurement of a battery; and
calculating a state-of-charge estimate using a calculated total battery coulomb count and an obtained voltage measurement.

15. The non-transitory computer readable storage medium of claim 14, wherein receiving the local coulomb count occurs at about 0.1 to 10 Hz or times per second.

16. The non-transitory computer readable storage medium of claim 14, wherein the state-of-charge estimate of the battery is calculated using Equation (1):
$$SoC = f ( {Q}_{ctot} , {V}_{batt} ) , \qquad ( 1 )$$
where Q_{ctot}=sum (Q_{c1} . . . Q_{cN}), and the voltage measurement is a battery pack voltage measurement V_{batt}.

17. The non-transitory computer readable storage medium of claim 14, wherein the power converter comprises four microinverters.

18. The non-transitory computer readable storage medium of claim 17, wherein the local coulomb count is performed @ (N−1) Hz, where N is a number of microinverters.

19. The non-transitory computer readable storage medium of claim 18, wherein the power converter is one of an AC-DC power converter or a DC-DC power converter.
